(19) United States
(12) Patent Application Publication
(10) Pub. No.: US 2019/0183025 A1
(43) Pub. Date: Jun. 20, 2019

(54) Weed Removal System

(71) Applicants: Jon Muncan, Guelph (CA); Randy Zurbrigg, Guelph (CA)

(72) Inventors: Jon Muncan, Guelph (CA); Randy Zurbrigg, Guelph (CA)

(21) Appl. No.: 15/849,236

(22) Filed: Dec. 20, 2017

(51) Int. Cl. A01B 1/16; A01D 11/06

(52) U.S. Cl. CPC A01B 1/16; A01D 7/02; A01D 11/06

(57) ABSTRACT

A weed removal system for removing weeds with a rake includes a rake that is manipulated for raking debris on ground. The rake has a handle and a head and a tube is removably coupled to the rake. A poker is removably coupled to the tube such that the poker extends beyond the head. The poker selectively penetrates the ground adjacent to a weed thereby facilitating the weed to be pried out of the ground.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to weeding devices and more particularly pertains to a new weeding device for removing weeds with a rake.

### BRIEF SUMMARY OF THE INVENTION

An embodiment of the disclosure meets the needs presented above by generally comprising a rake that is manipulated for raking debris on ground. The rake has a handle and a head and a tube is removably coupled to the rake. A poker is removably coupled to the tube such that the poker extends beyond the head. The poker selectively penetrates the ground adjacent to a weed thereby facilitating the weed to be pried out of the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a poker and a tube of a weed removal system according to an embodiment of the disclosure.

FIG. 2 is a perspective view of an embodiment of the disclosure.

FIG. 3 is a top view of a poker and a tube of an embodiment of the disclosure.

FIG. 4 is a top view of a tube of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

### DETAILED DESCRIPTION OF THE INVENTION

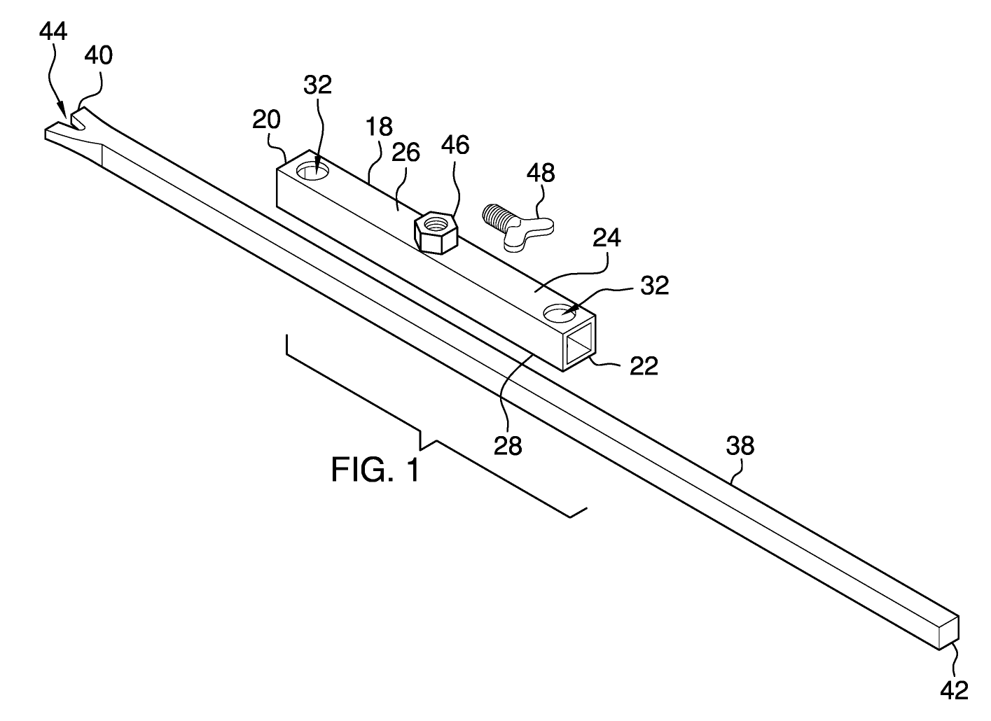

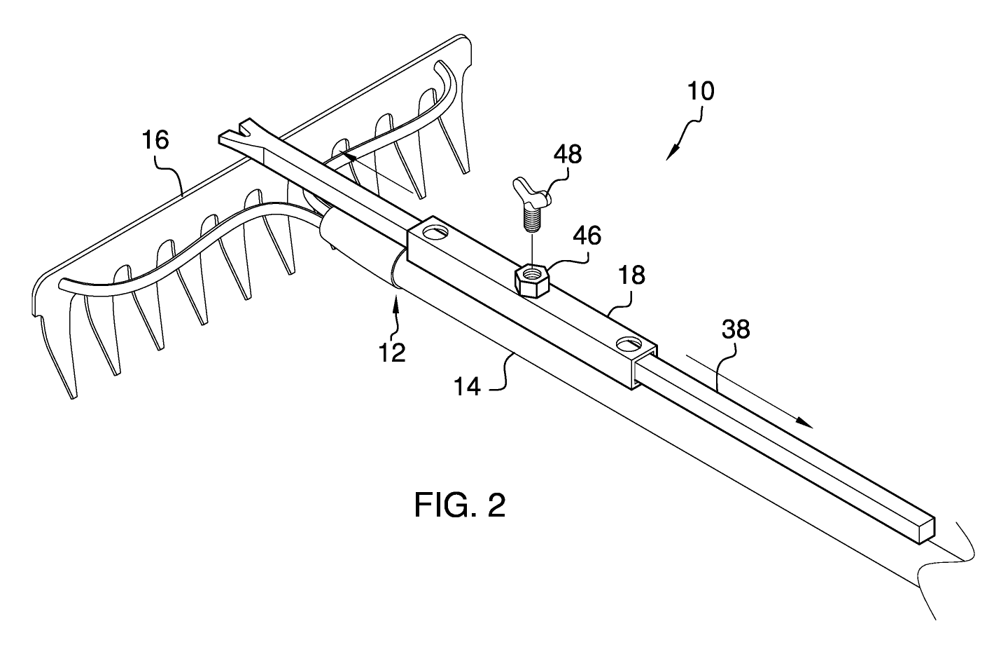

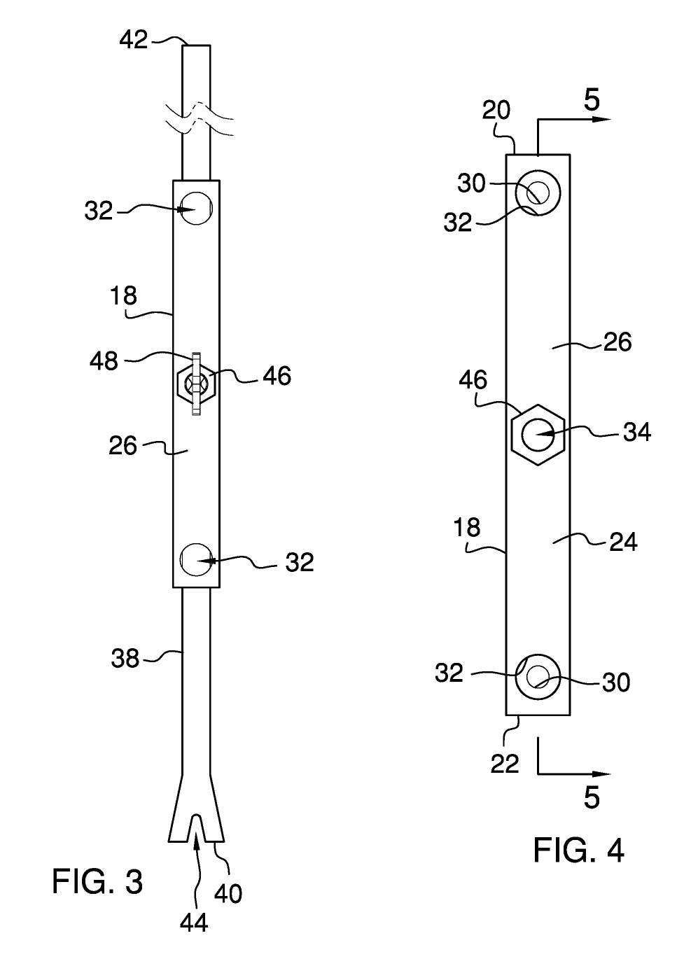

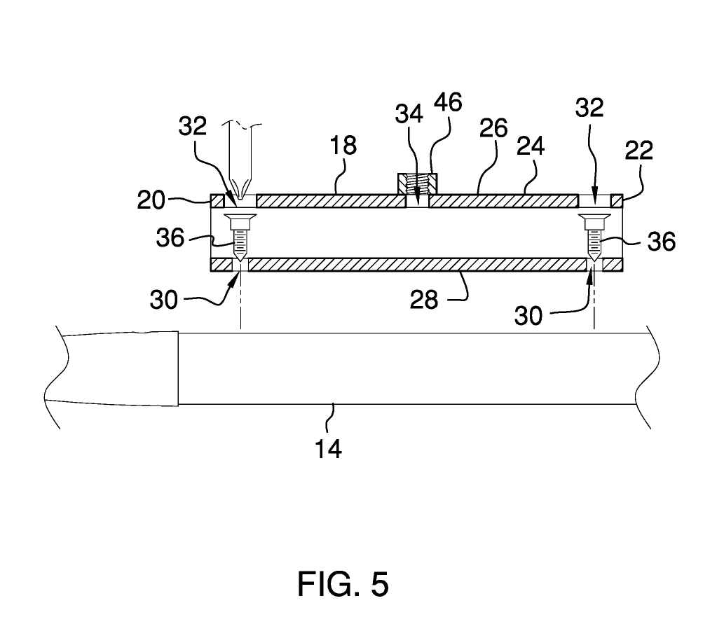

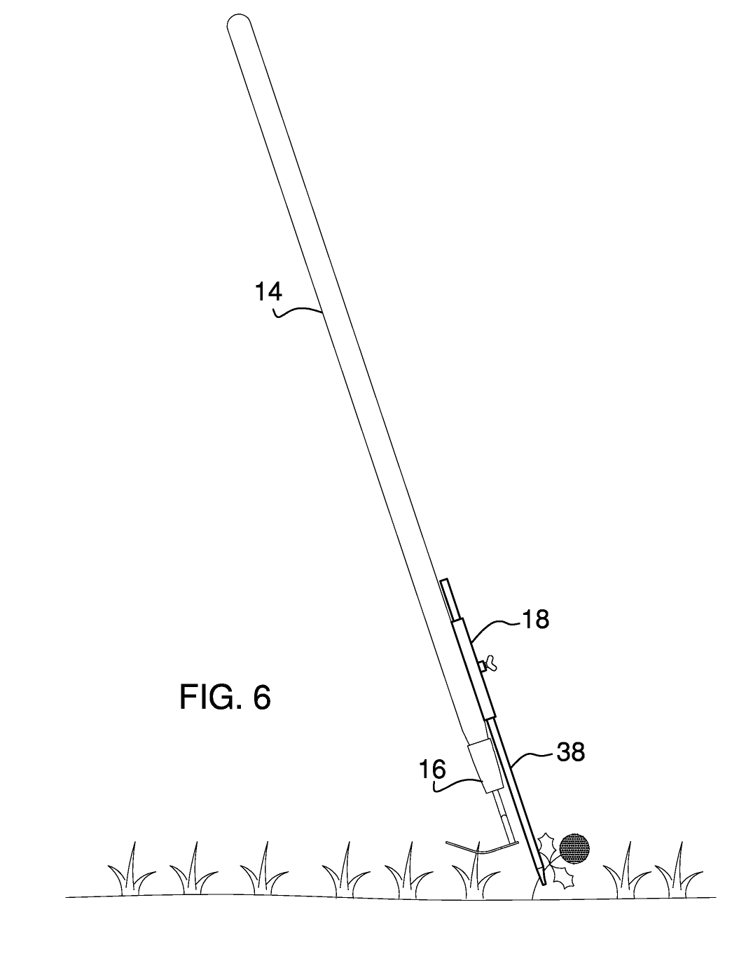

With reference now to the drawings, and in particular to FIGS. 1 through 6 thereof, a new weeding device embodying the principles and concepts of an embodiment of the disclosure and generally designated by the reference numeral 10 will be described.

As best illustrated in FIGS. 1 through 6, the weed removal system 10 generally comprises a rake 12 that is selectively manipulated for raking debris on ground. The rake 12 has a handle 14 and a head 16 and the rake 12 may be a yard rake 12 of any conventional design. A tube 18 is provided and the tube 18 is removably coupled to the rake 12. The tube 18 has a first end 20, a second end 22 and an outer wall 24 extending therebetween and the outer wall 24 has a top side 26 and a bottom side 28.

The bottom side 28 has a pair of first apertures 30 extending into an interior of the tube 18 and the first apertures 30 are spaced apart from each other. The tube 18 is positioned on the handle 14 having the bottom side 28 lying on the handle 14 and having the tube 18 being oriented collinear with the handle 14. Moreover, the tube 18 is positioned adjacent to the head 16. The top side 26 has a pair of second apertures 32 extending into the interior of the tube 18 and each of the second apertures 32 is aligned with an associated one of the first apertures 30. Each of the second apertures 32 has a diameter that is greater than a diameter of the first apertures 30. The top side 26 has a third aperture 34 extending into the interior of the tube 18 and the third aperture 34 is centrally positioned between the second apertures 32.

A pair of screws 36 is provided and each of the screws 36 is extended through an associated one of the first apertures 30 and engages the handle 14 to retain the tube 18 on the rake 12. A screwdriver or other elongated tool is selectively extended through each of the second apertures 32 for tightening the screws 36. Each of the screws 36 may be wood screws 36 or other screws 36 corresponding to a material of the handle 14.

A poker 38 is provided and the poker 38 is removably coupled to the rake 12. The poker 38 extends beyond the head 16. Thus, the rake 12 is selectively manipulated to facilitate the poker 38 to penetrate the ground adjacent to a weed. In this way poker 38 may pry the weed out of the ground. The poker 38 has a first end 40 and a second end 42 and the poker 38 is elongated between the first end 40 and the second end 42. The first end 40 of the poker 38 has a slot 44 extending toward the second end 42 of the poker 38 and the weed positioned in the slot 44 when the poker 38 is manipulated to penetrate the ground. The poker 38 is slid ably positioned in the tube 18 such that the poker 38 extends beyond the head 16 thereby facilitating the first end 40 of the poker 38 to penetrate the ground.

A nut 46 is provided and the nut 46 is coupled to the top side 26 of the tube 18. The nut 46 is aligned with the third aperture 34 in the tube 18. A bolt 48 is provided and the bolt 48 thread ably engages the nut 46. The bolt 48 frictionally engages the poker 38 when the bolt 48 is tightened to retain the poker 38 in the tube 18. The bolt 48 may be a thumb screw or other threaded fastener.

In use, the tube 18 is coupled to the handle 14 of the rake 12 at a selected point along the handle 14. The poker 38 is slid ably inserted into the tube 18 and the poker 38 is manipulated to facilitate the poker 38 to extend a selected distance beyond the head 16 of the rake 12. The bolt 48 is tightened to retain the poker 38 in the tube 18. The rake 12 is manipulated to facilitate the poker 38 to penetrate the ground next to a weed. The rake 12 is urged downwardly thereby facilitating the poker 38 to pry the weed upwardly out of the ground. In this way the weed is removed from the ground without requiring bending over.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weed removal system being configured to be manipulated for removing weeds from an area, said system comprising:
a rake being configured to be manipulated for raking debris on ground, said rake having a handle and a head;
a tube being removably coupled to said rake; and
a poker being removably coupled to said tube such that said poker extends beyond the said head wherein said poker is configured to selectively penetrate the ground adjacent to a weed thereby facilitating the weed to be pried out of the ground.

2. The assembly according to claim 1, wherein said tube has a first end, a second end and an outer wall extending therebetween, said outer wall having a top side and bottom side, said bottom side having a pair of first apertures extending into an interior of said tube, said first apertures being spaced apart from each other, said tube being positioned on said handle having said bottom side lying on said handle and having said tube being oriented collinear with said handle, said tube being spaced from said head.

3. The assembly according to claim 2, wherein said top side has a pair of second apertures extending into said interior of said tube, each of said second apertures being aligned with an associated one of said first apertures.

4. The assembly according to claim 3, wherein said top side has a third aperture extending into said interior of said tube, said third aperture being centrally positioned between said second apertures.

5. The assembly according to claim 3, further comprising a pair of screws, each of said screws being extended through an associated one of said first apertures and engaging said handle to retain said tube on said rake, each of said second apertures being configured to have a screwdriver extended there through for tightening said screws.

6. The assembly according to claim 2, wherein said poker has a first end and a second end, said poker being elongated between said first end and said second end, said first end having a slot extending toward said second end wherein said slot is configured to have the weed positioned therein when said poker is manipulated to penetrate the ground, said poker being slid ably positioned in said tube such that said poker extends beyond the said head wherein said first and is configured to penetrate the ground.

7. The assembly according to claim 6, further comprising a nut being coupled to said top side of said tube, said nut being aligned with said third aperture in said tube.

8. The assembly according to claim 7, further comprising a bolt thread ably engaging said nut wherein said bolt is configured to be manipulated, said bolt frictionally engaging said poker when said bolt is tightened to retain said poker in said tube.

9. A weed removal system being configured to be manipulated for removing weeds from an area, said system comprising:
a rake being configured to be manipulated for raking debris on ground, said rake having a handle and a head;
a tube being removably coupled to said rake, said tube having a first end, a second end and an outer wall extending therebetween, said outer wall having a top side and bottom side, said bottom side having a pair of first apertures extending into an interior of said tube, said first apertures being spaced apart from each other, said tube being positioned on said handle having said bottom side lying on said handle and having said tube being oriented collinear with said handle, said tube being spaced from said head, said top side having a pair of second apertures extending into said interior of said tube, each of said second apertures being aligned with an associated one of said first apertures, said top side having a third aperture extending into said interior of said tube, said third aperture being centrally positioned between said second apertures;
a pair of screws, each of said screws being extended through an associated one of said first apertures and engaging said handle to retain said tube on said rake, each of said second apertures being configured to have a screwdriver extended there through for tightening said screws;
a poker being removably coupled to said tube such that said poker extends beyond the said head wherein said poker is configured to selectively penetrate the ground adjacent to a weed thereby facilitating the weed to be pried out of the ground, said poker having a first end and a second end, said poker being elongated between said first end and said second end, said first end having a slot extending toward said second end wherein said slot is configured to have the weed positioned therein when said poker is manipulated to penetrate the ground, said poker being slid ably positioned in said tube such that said poker extends beyond the said head wherein said first and is configured to penetrate the ground;
a nut being coupled to said top side of said tube, said nut being aligned with said third aperture in said tube; and
a bolt thread ably engaging said nut wherein said bolt is configured to be manipulated, said bolt frictionally engaging said poker when said bolt is tightened to retain said poker in said tube.
